(19) United States
(12) Patent Application Publication
(10) Pub. No.: US 2013/0052999 A1
(43) Pub. Date: Feb. 28, 2013

(54) PAGER WITH MULTIPLE RESPONSE PROGRAMS

(71) Applicants: SHIN-TSENG YEH, New Taipei City (TW); Yi-Ming Huang, New Taipei City (TW)

(72) Inventors: SHIN-TSENG YEH, New Taipei City (TW); Yi-Ming Huang, New Taipei City (TW)

(73) Assignee: Unication Group/Unication Co., LTD., New Taipei City (TW)

(21) Appl. No.: 13/543,827

(22) Filed: Jul. 7, 2012

(30) Foreign Application Priority Data
Aug. 31, 2011 (TW) 100131412

(51) Int. Cl. H04W 4/12; H04W 24/00; G08B 5/22

(52) U.S. Cl. 455/412.2; 340/7.22; 455/456.1

(57) ABSTRACT

A pager with multiple response programs capable of acknowledging receipt of messages by transmitting an acknowledgement, wherein the pager is capable of automatically transmitting an acknowledgement (Ack) message to a console (or a dispatching center) when receiving a call alert signal, and is capable of manually transmitting an Ack message of obtaining and reading a dispatching message to the console when receiving the dispatching message (or a paging message), and is capable of manually or automatically selecting an Ack message from a responding list pre-stored in the pager and transmitting the Ack message being selected to the console. Furthermore, the pager is capable of accessing a server of the console to retrieve a dispatching message when the pager transmits an Ack message to the console.

### BACKGROUND OF THE INVENTION

1. Field of the Invention

The present invention relates to a pager with multiple response programs, and more particularly to a text or voice pager having a function of communicating over a Global System for Mobile Communications (GSM) system, and comprising a process unit installed with the multiple response programs which are being automatically or manually executed to transmit an acknowledgement message to a console over the GSM system.

2. Related Art

Generally, conventional text or voice pagers applicable in a paging system are widely used for the police, fire fighting, medical, rescue and military affairs. When receiving a call alert signal from a console, a conventional text or voice pager is unable to transmit an acknowledgement (Ack) to the console to confirm that the call alert is being received, and such conventional pager is known as one-way pagers. Therefore, a conventional pager is then improved to be equipped with a Global System for Mobile Communications (GSM) module in order to automatically transmit the Ack to the console when receiving a call alert (e.g. 2-tone alert signal). Except for transmitting the Ack, the conventional pager is not allowed to provide more or further information to the console. As a result, an operator of the console could not have the real status of whether a user of the pager successfully receives a dispatching message (paging message) in full content, or what actions the user is going to take after receiving the message.

For another instance, a conventional pager having a GSM lunching module is capable of receiving a dispatching message directly from a console or indirectly from a repeater. Upon receiving the message, the pager utilizes pre-installed programs to automatically transmit an Ack message to the console to let an operator of the console knows that the message has been transmitted to one or more selected pagers. However, the Ack message is automatically transmitted to the console immediately after the pager receives the alert signal. In other words, the operator of the console still could not get more information and status of the pager's user, and the pager's user could not successfully express what action is to be taken after receiving the message. For example, even though the message is being received by the user of the pager, the operator of the console could not know whether the user has read or listened to the message, whether the user can accept the dispatch at once, when can get to an event scene, or need any support, and so on. The above-mentioned problems could not be overcome by conventional pagers, and seriously affect usability of a paging system and pager.

### SUMMARY OF THE INVENTION

Accordingly, an object of the present invention is to provide a pager having various response programs which can be selected by manual operation or by programmed setting to automatically or manually transmit an acknowledgement (Ack) message to a console (or dispatching center) so as to enable an operator of the console to fully control a status of each user of the pager.

In accordance with present invention, the pager with multiple response programs of the present invention comprises a process unit and a GSM transmitting module which allows the pager to transmit an Ack message to the console over a GSM (GPRS) system in a paging system, wherein the process unit comprises the multiple response programs comprising an Ack response program for automatically transmitting an Ack to the console when a call alert signal is received by the pager, and at least one of a reading message response program and a selecting message response program. The reading message response program is configured to manually transmit an Ack of obtaining and reading the dispatching message to the console, and the selecting message response program is configured to manually transmit an Ack of a canned message from a responding list to the console, wherein the responding list includes multiple canned messages which are pre-stored in the pager.

In accordance with present invention, the multiple response programs further comprise at least one of subprograms including a power on/off response program, a duty response program, a re-transmitting response program, a monitoring response program, and an area response program, wherein the at least one of subprograms is capable of being executed by manual setting or by programmed setting to automatically transmit a corresponding Ack message to the console over the GSM system when a status related to the at least one of subprograms is changed.

In accordance with present invention, the pager further comprises a Global Positioning System (GPS) receiver module for receiving coordinate information from a GPS satellite, and being capable of transmitting current coordinate information of the pager to the console over the GSM system at the time when the pager transmits the Ack message to the console.

### BRIEF DESCRIPTION OF THE DRAWINGS

FIG. 1 is a circuit block diagram of a pager of the present invention;

FIG. 2 is a schematic diagram showing an example of the configuration of a communication system in accordance with an embodiment of the pager of FIG. 1;

FIG. 3 is another circuit block diagram of the pager of the present invention;

FIG. 4 is a schematic diagram showing an example of the configuration of a communication system in accordance with an embodiment of the pager of FIG. 3;

FIG. 5 is another circuit block diagram of the pager of the present invention; and

FIG. 6 is a schematic diagram showing an example of the configuration of a communication system in accordance with an embodiment of the pager of FIG. 5.

### DESCRIPTION OF THE PREFERRED EMBODIMENTS

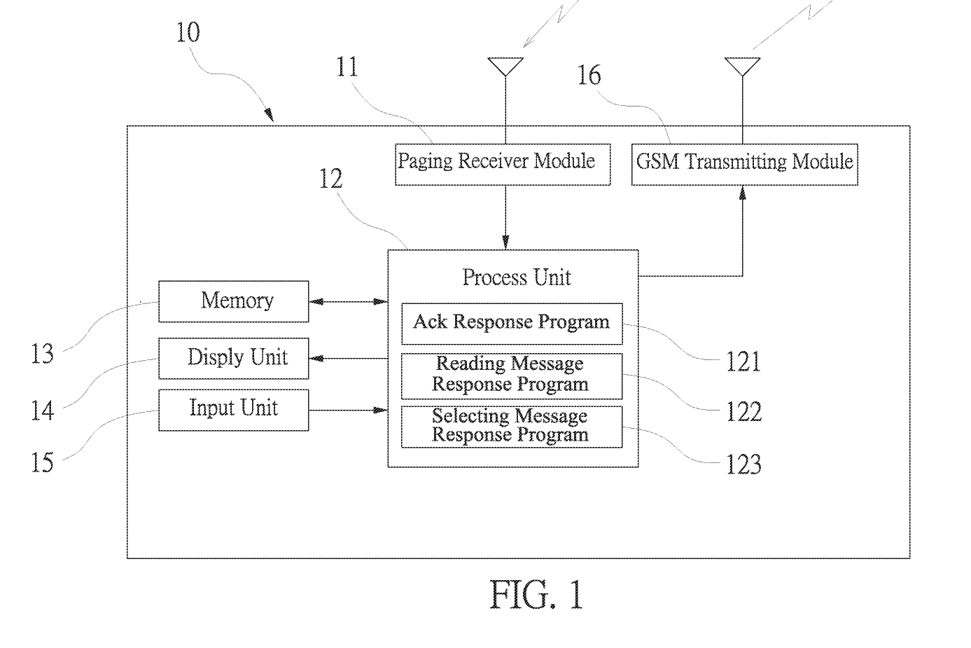

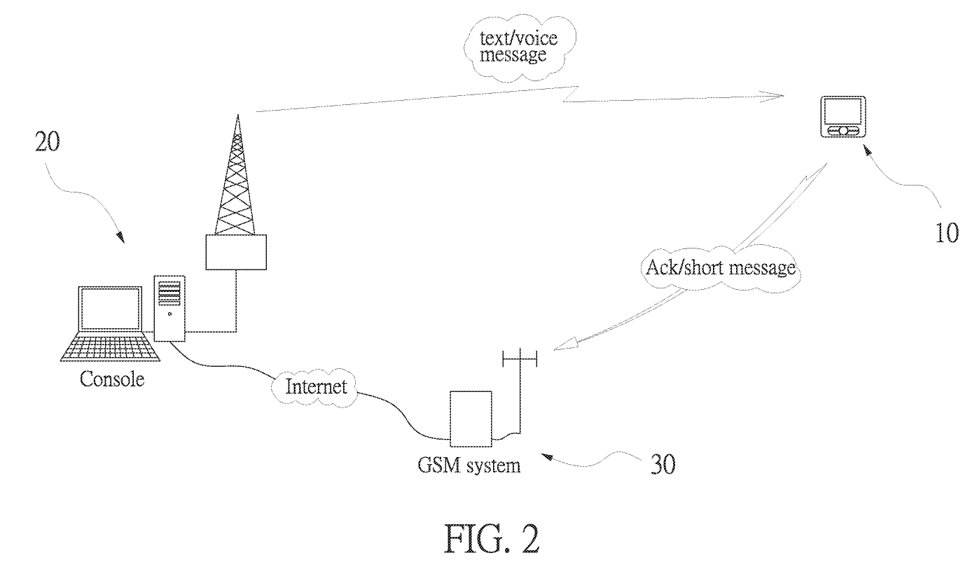

Referring to FIGS. 1 and 2, a two-way pager 10 with multiple response programs in accordance with the present invention comprises a process unit 12 electrically coupled with a paging receiver module 11, a memory 13, a display unit 14, an input unit 15, and a Global System for Mobile Communications (GSM) transmitting module 16. The process unit 12 is configured to receive a dispatching message through the paging receiver module 11, and transmit an acknowledgement (Ack) message in Short Message Service (SMS) format through the GSM transmitting module 16 to a console (dispatching center) 20 over a GSM system 30. The process unit 12 is embedded with the multiple response programs by the way of burning or writing in software programs. The multiple response programs comprise an Ack response program 121 for automatically transmitting an Ack to the console 20 when a call alert signal is received by the pager 10, and at least one of a reading message response program 122 and a selecting message response program 213.

The reading message response program 122 is configured to manually transmit an Ack of obtaining and reading the dispatching message to the console 20.

The selecting message response program 123 is configured to manually transmit an Ack of a canned message from a responding list to the console 20, wherein the responding list includes multiple canned messages which are pre-stored in the process unit 12 or the memory 13. The canned messages are messages containing, such as, for example, “accept the dispatch”, “unable to go”, “go later”, “delay in 30 minutes”, “request for re-transmitting the message”, or “request for transmitting a text message” (but not limited thereby). The above-mentioned canned messages are selectable from the responding list indicated on the display unit 14 by manipulating the input unit 15, wherein the answer being selected is transmitted as an Ack to the console 20 through the GSM transmitting module 16 over the GSM system 30 so as to enable users (members) to clearly express a status of the reception signals and a future action, whereby an operator (or a commander) can effectively control each user's status.

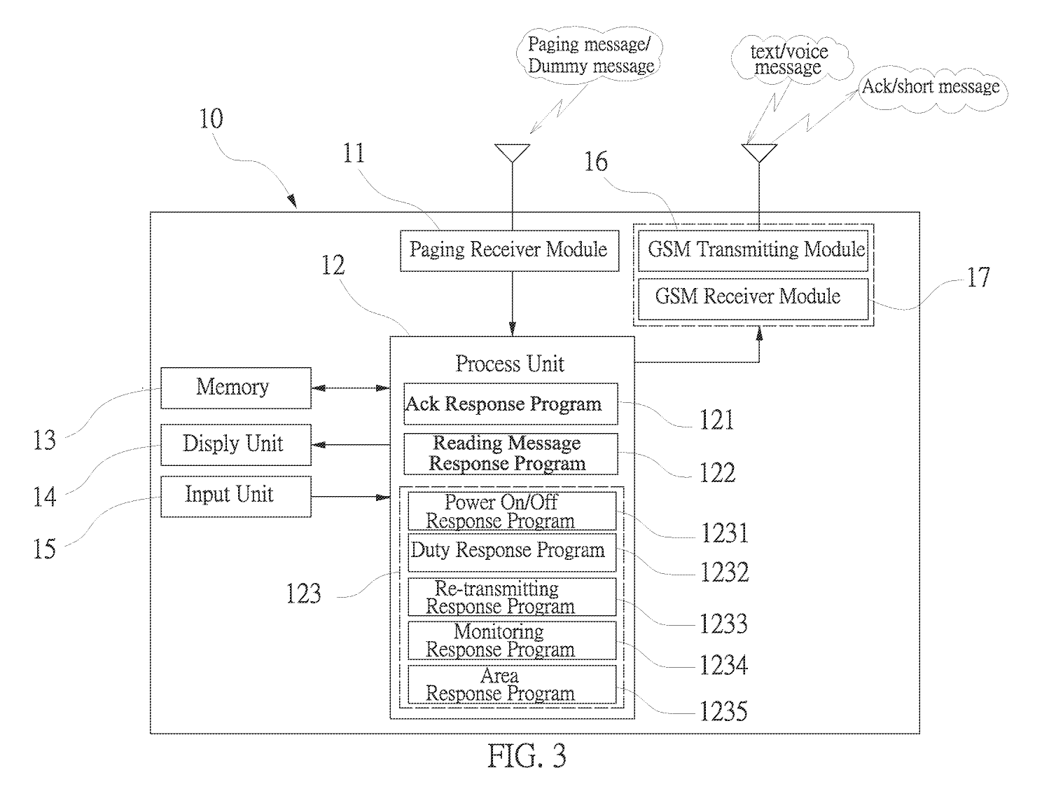

Referring to FIG. 3, the multiple response programs further comprise at least one of subprograms including a power on/off response program 1231, a duty response program 1232, a re-transmitting response program 1233, a monitoring response program 1234, and an area response program 1235. The subprograms are included in the selecting message response program 123, and are capable of being executed by manual setting from the responding list indicated on the display unit 14, or executed automatically by programmed setting. The pager 10 utilizes the subprogram being selected to detect or determine a status of the pager 10, and then automatically transmits a corresponding Ack message to the console 20 when the status is changed, wherein the Ack message is displayed on a screen of the console 20 for indicating the current status of each member (pager). Given below are detailed descriptions of how the subprograms work.

When the pager 10 is manually or automatically powered on, the power on/off response program 1231 is configured to automatically initiate the GSM transmitting module 16 so as to transmit a corresponding Ack message of power on in Short Message Service (SMS)/GPRS format to the console 20 over the GSM system 30. Likewise, before the pager 10 is powered off the power on/off response program 1231 is configured to automatically initiate the GSM transmitting module 16 to transmit a corresponding Ack message of power off to the console 20, whereby to enable the console 20 or a dispatching center to instantly know how many members are on line.

When a status of the pager 10 is manually set to be off duty, the duty response program 1232 is configured to automatically transmit a corresponding Ack message of off duty to the console 20 over the GSM system 30 so as to indicate that the pager (user) is in the period of off-duty (such as on leave or busy) during which the pager 10 temporarily stops the function of receiving messages and triggering an alert sound so as to avoid being disturbed. Likewise, when the pager 10 is manually or automatically set to return to the status of on duty, the duty response program 1232 is configured to automatically transmit a corresponding Ack message of on duty to the console 20 over the GSM system 30 so as to indicate that the pager is in a standby status.

When the pager 10 is far away from the console 20 and only available to receive a call alert sound but no signal of a dispatching message, the re-transmitting response program 1233 is configured to automatically transmit a corresponding Ack message of unsuccessfully receiving a dispatching message or of requesting a re-transmitting to the console 20 over the GSM system 30. Additionally, when the pager 10 is in the condition of weak signal (such as receives an incomplete message or cannot listen to a message clearly), the user is allowed to manually transmit an Ack message of unsuccessfully receiving a message or of requesting for transmitting again to the console 20 so as to enable the operator of console 20 to re-transmit such message.

When the pager 10 is put on a charger 40 which receives a detection signal from a control box device (not shown) intended to monitor and control external electronic or mechanical devices, provided that the detection signal is being changed, the charger 40 will transmit a signal to the pager 10, and the monitoring response program 1234 is configured to automatically transmit a corresponding Ack message of the detection signal being changed to the console 20 over the GSM system 30, whereby the operator is capable of performing a remote control through the console 20 or notifying related staff for further actions.

When the pager 10 being powered on is out of a communication range and fails to receive a dummy message or detection signal one time or many times from the console 20 in a set period of time, the area response program 1235 is configured to enable the pager 10 to automatically initiate the GSM transmitting module 16 to transmit an Ack message of out of range to the console 20 over the GSM system 30. Additionally, once the pager 10 is within the communication range and resumes receiving the dummy message or detection signal one time or many times in a set period of time, the pager 10 also automatically initiates the GSM transmitting module 16 to transmit an Ack message of within range to the console 20 over the GSM system 30.

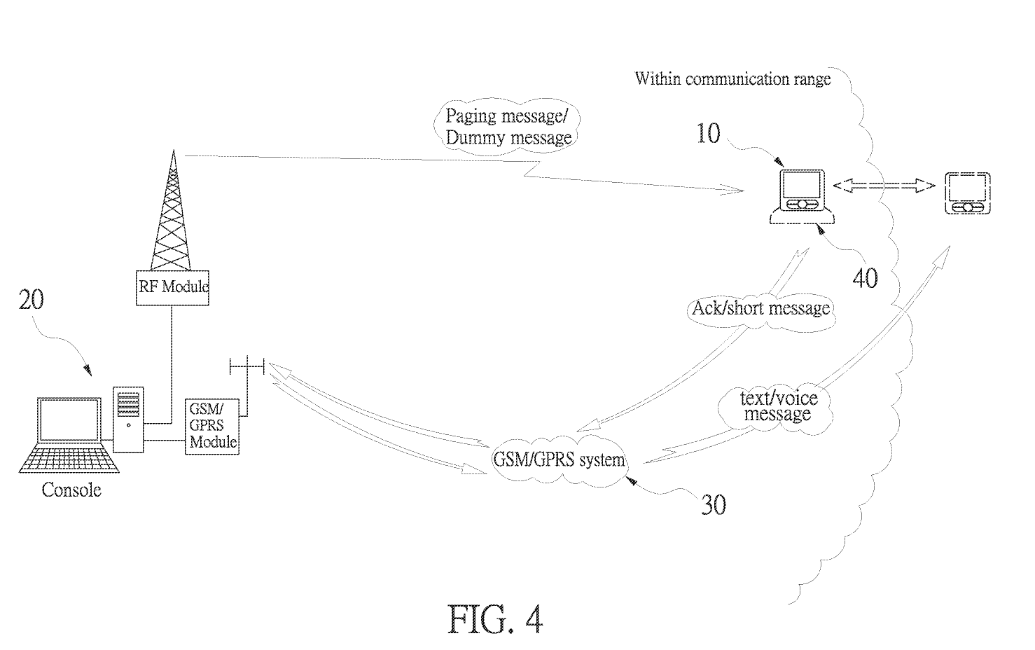

Continuing referring to FIG. 3, the pager 10 further comprises a GSM receiver module 17 (capable of being combined with the GSM transmitting module 16 as a GSM transceiver module). The area response program 1235 further has a function of automatically initiating the GSM receiver module 17 which is performed in the event that the pager 10 is out of the communication range and transmits the Ack message of out of range to the console 20. Therefore, the pager 10 is allowed to receive a dispatching message over the GSM system 30 instead of over a paging system (as shown in FIG. 4) because a GSM system usually covers a larger communication range than a paging system covers. As a result, the pager 10 is automatically switched to receive a dispatching message over the GSM system 30 in order to be used in a larger area.

With respect to the pager 10 of the GSM receiver module 17 as described above, when the console 20 receives the Ack message of unsuccessfully receiving a dispatching message, the console 20, according to a program setting, is allowed to automatically re-transmit the dispatching message to the pager 10 over the GSM system 30 so as to enable the pager 10 to effectively regain missed messages. Furthermore, when the console 20 receives the Ack message of the detection signal being changed, the console 20, according to a program setting, is allowed to automatically re-transmit a control command to the pager 10 over the GSM system 30 so as to control an external device (not shown) through the charger 40.

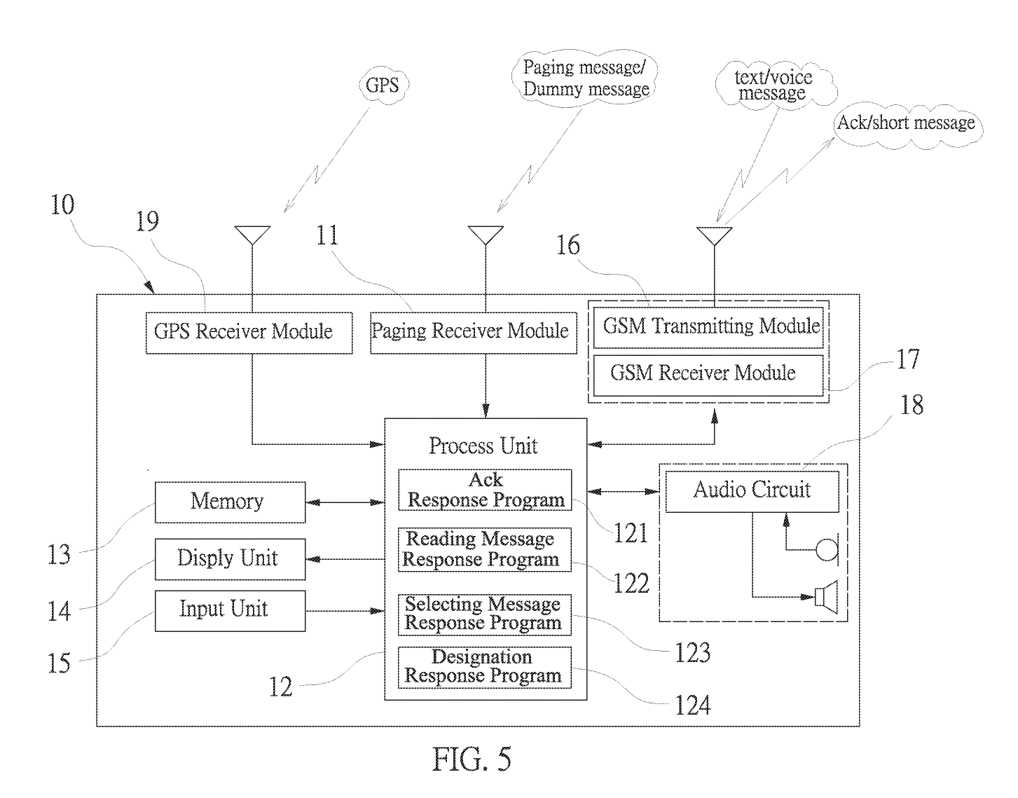

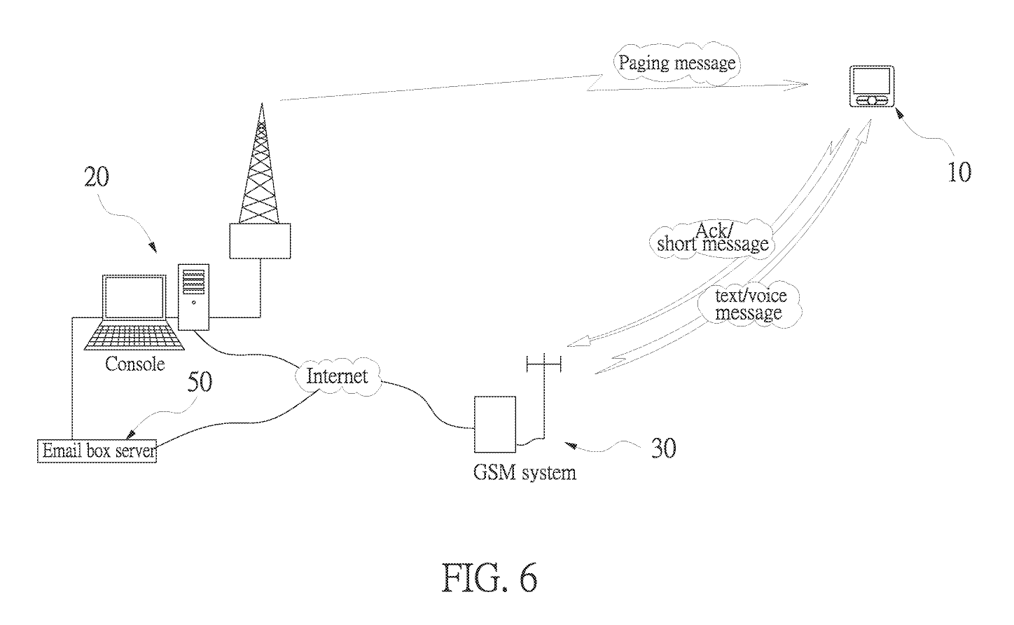

Referring to FIG. 5 for another embodiment of present invention, the pager 10 further comprises an audio circuit 18 (for playing and receiving sounds), and the console 20 is electrically coupled with an email server 50 intended to simultaneously receive and store dispatching messages transmitted by the console 20 (or a dispatching center). Moreover, the multiple response programs further comprises a designation response program 124 comprising an assigned communication address of the email server 50. When a member cannot clearly listen to a message or receives an incomplete message, the designation program is automatically or manually executed to transmit a control message to the email server 50 over the GSM system 30 to retrieve a dispatching message previously stored (or failed to be received), according to the assigned communication address. Then the dispatching message being retrieved in GSM/GPRS format is re-transmitted to the pager 10 over the GSM system 30 (as shown in FIG. 6). In this manner, the pager 10 (user) is capable of listening to or reading the message failed to be received, or even obtaining a dispatching message that is being converted from a voice message into a text message.

Referring to FIG. 5, the pager 10 further comprises a Global Positioning System (GPS) receiver module 19 for receiving coordinate information from a GPS satellite, and being capable of transmitting current coordinate information of the pager 10 to the console 20 over the GSM system 30 at the time when the pager 10 transmits the Ack message to the console 20, particularly when the Ack message is transmitted by the power on/off response program 1231, the duty response program 1232, the re-transmitting response program 1233, and the area response program 1235. The coordinate information of the pager 10 is displayed on a screen of the console 20 to indicate the location of the member using such pager 10 so as to facilitate further control or management of the control.

It is understood that the invention may be embodied in other forms within the scope of the claims. Thus the present examples and embodiments are to be considered in all respects as illustrative, and not restrictive, of the invention defined by the claims.

What is claimed is:

1. A pager with multiple response programs, the pager comprising:
a process unit electrically coupled with a paging receiver module, a memory, a display unit, an input unit, and a Global System for Mobile Communications (GSM) transmitting module, the process unit configured to receive a dispatching message over a paging system, and transmit an acknowledgement (Ack) message to a console over a GSM system;
wherein the process unit comprises the multiple response programs comprising an Ack response program for automatically transmitting an Ack to the console when a call alert signal is received by the pager, and at least one of a reading message response program and a selecting message response program, the reading message response program configured to manually transmit an Ack of obtaining and reading the dispatching message to the console, and the selecting message response program configured to manually transmit an Ack of a canned message from a responding list to the console, wherein the responding list includes multiple canned messages which are pre-stored in the pager.

2. The pager of claim 1, wherein the multiple response programs further comprise at least one of subprograms including a power on/off response program, a duty response program, a re-transmitting response program, a monitoring response program, and an area response program, wherein the at least one of subprograms is capable of being executed by manual setting or by programmed setting to automatically transmit a corresponding Ack message to the console over the GSM system when a status related to the at least one of subprograms is changed.

3. The pager of claim 2, wherein the power on/off response program is configured to automatically transmit a corresponding Ack message of power on or off to the console over the GSM system when the pager is manually or automatically powered on/off.

4. The pager of claim 2, wherein the duty response program is configured to automatically transmit a corresponding Ack message of on duty or off duty to the console over the GSM system when a status of the pager is manually set between on duty or off duty.

5. The pager of claim 2, wherein the re-transmitting response program is configured to automatically or manually transmit a corresponding Ack message of unsuccessfully receiving a dispatching message to the console over the GSM system when after the pager receives a call alert sound, but unsuccessfully or incompletely receives the dispatching message.

6. The pager of claim 2, wherein when the pager is put on a charger which receives a detection signal from a control box device, provided that the detection signal is being changed, the charger will transmit a signal to the pager, and the monitoring response program is configured to automatically transmit a corresponding Ack message of the detection signal being changed to the console over the GSM system.

7. The pager of claim 2, the area response program is configured to automatically transmit a corresponding Ack message of out of range or within range to the console over the GSM system when the pager is leaving or entering a communication area.

8. The pager of claim 7, further comprising a GSM receiver module intended to receive a text/voice message from the console, the area response program is further configured to automatically execute the GSM receiver module so as to remain the pager in a standby status where the GSM receiver module is being executed, and the text/voice message from the console is received over the GSM system.

9. The pager of claim 1, wherein the console is further coupled with an email server for simultaneously receiving and storing a paging message from the console, the pager further comprises a GSM receiver module, and the multiple response programs further comprise a designation response program comprising an assigned communication address of the email server, wherein the designation program is automatically or manually executed to access the email server over the GSM system, according to the assigned communication address, to retrieve a dispatching (paging) message previously stored in the email server and then transmit the dispatching message being retrieved to the pager over the GSM system.

10. The pager of claim 1, further comprising a Global Positioning System (GPS) receiver module for receiving coordinate information from a GPS satellite, and being capable of transmitting current coordinate information of the pager together with an Ack message to the console over the GSM system.
